(19) United States
(12) Patent Application Publication
(10) Pub. No.: US 2024/0292432 A1
(43) Pub. Date: Aug. 29, 2024

(54) RESOURCE RE-SELECTION BASED ON PRE-CONFLICT INDICATION

(71) Applicant: QUALCOMM INCORPORATED, San Diego, CA (US)

(72) Inventors: Shuanshuan Wu, San Diego, CA (US); Kapil Gulati, Belle Mead, NJ (US); Gabi Sarkis, San Diego, CA (US); Tien Viet Nguyen, Bridgewater, NJ (US); Sourjya Dutta, San Diego, CA (US); Hui Guo, Beijing (CN)

(21) Appl. No.: 18/573,643

(22) PCT Filed: Aug. 27, 2021
(86) PCT No.: PCT/CN2021/115001

§ 371 Date: Dec. 22, 2023

(51) Int. Cl. H04W 72/25; H04L 43/0852

(52) U.S. Cl. CPC H04W 72/25; H04L 43/0852

(57) ABSTRACT

Methods, systems, and devices for wireless communications are described. A first user equipment (UE) may transmit a control message indicating reservation of a first resource of a sidelink channel for a sidelink transmission. The first UE may receive a pre-conflict indication for the first resource based on the control message. In some cases, the first UE may disregard the pre-conflict indication, or may not disregard the conflict indication based on one or more factors. The first UE may perform resource re-selection to select a second resource for the sidelink transmission if the first UE receives the conflict indication at least a threshold amount of time prior to the first resource, and may transmit using the second resource. Otherwise, the first UE may report a negative acknowledgement (NACK) message from a physical (PHY) layer to a medium access control (MAC) layer.

### CROSS REFERENCE

The present Application is a 371 national stage filing of International PCT Application No. PCT/CN2021/115001 by Wu et al. entitled “RESOURCE RESELECTION BASED ON PRE-CONFLICT INDICATION,” filed Aug. 27, 2021, which is assigned to the assignee hereof, and which is expressly incorporated by reference in its entirety herein.

### FIELD OF TECHNOLOGY

The following relates to wireless communications, including resource re-selection based on pre-conflict indication.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communications systems, UEs may reserve resources for future sidelink transmissions. However, such UEs may reserve resources that conflict with reservations made by other UEs.

### SUMMARY

The described techniques relate to improved methods, systems, devices, and apparatuses that support resource re-selection based on pre-conflict indication. The described techniques may enable a first user equipment (UE) to re-select a resource for a transmission based on a received pre-conflict indication. For example, a first UE may transmit a control message indicating reservation of a first resource of a sidelink channel for a sidelink transmission to a second UE. The first UE may receive a pre-conflict indication for the first resource indicating that a different UE (e.g., the second UE, or any other UE) has reserved the first resource for a transmission. In some cases, the first UE may disregard the pre-conflict indication, or may not disregard the conflict indication based on one or more factors (e.g., a remaining packet delay budget (PDB), a priority associated with the transmission by the first UE, a determination that the first UE has received a high number of pre-conflict indications, or any combination thereof). In cases where the first UE does not disregard the pre-conflict indication, the first UE may perform resource re-selection to select a second resource for the sidelink transmission if the first UE receives the conflict indication at least a threshold amount of time prior to the first resource, and may transmit using the second resource. Otherwise, the first UE may report a negative acknowledgement (NACK) message from a physical (PHY) layer to a medium access control (MAC) layer, and may perform resource re-selection at a later time.

A method for wireless communication at a first UE is described. The method may include transmitting a control message indicating reservation of a first resource of a sidelink channel for a sidelink transmission, receiving, from a second UE, a conflict indication indicating a reservation conflict for the first resource based on the control message, performing resource selection to select a second resource based on receiving the conflict indication, and transmitting the sidelink transmission using the second resource.

An apparatus for wireless communication at a first UE is described. The apparatus may include a processor, memory coupled with the processor, and instructions stored in the memory. The instructions may be executable by the processor to cause the apparatus to transmit a control message indicating reservation of a first resource of a sidelink channel for a sidelink transmission, receive, from a second UE, a conflict indication indicating a reservation conflict for the first resource based on the control message, perform resource selection to select a second resource based on receiving the conflict indication, and transmit the sidelink transmission using the second resource.

Another apparatus for wireless communication at a first UE is described. The apparatus may include means for transmitting a control message indicating reservation of a first resource of a sidelink channel for a sidelink transmission, means for receiving, from a second UE, a conflict indication indicating a reservation conflict for the first resource based on the control message, means for performing resource selection to select a second resource based on receiving the conflict indication, and means for transmitting the sidelink transmission using the second resource.

A non-transitory computer-readable medium storing code for wireless communication at a first UE is described. The code may include instructions executable by a processor to transmit a control message indicating reservation of a first resource of a sidelink channel for a sidelink transmission, receive, from a second UE, a conflict indication indicating a reservation conflict for the first resource based on the control message, perform resource selection to select a second resource based on receiving the conflict indication, and transmit the sidelink transmission using the second resource.

In some examples of the method, apparatuses, and non-transitory computer-readable medium described herein, performing the resource selection may include operations, features, means, or instructions for performing the resource selection based on a remaining PDB for a packet in the sidelink transmission being greater than or equal to a threshold value corresponding to a time when the conflict indication may be received.

In some examples of the method, apparatuses, and non-transitory computer-readable medium described herein, performing the resource selection may include operations, features, means, or instructions for performing the resource selection based on a priority associated with the sidelink transmission being less than a priority threshold value.

In some examples of the method, apparatuses, and non-transitory computer-readable medium described herein, performing the resource selection may include operations, features, means, or instructions for performing the resource selection based on a conflict indication percentage during a time duration being less than a threshold percentage.

In some examples of the method, apparatuses, and non-transitory computer-readable medium described herein, performing the resource selection may include operations, features, means, or instructions for performing the resource selection based on a conflict indication percentage for a last quantity of transmitted control messages being less than a threshold percentage.

In some examples of the method, apparatuses, and non-transitory computer-readable medium described herein, performing the resource selection may include operations, features, means, or instructions for performing the resource selection based on a quantity of received conflict indications for consecutive resource reservations being less than a threshold.

Some examples of the method, apparatuses, and non-transitory computer-readable medium described herein may further include operations, features, means, or instructions for transmitting an indication of a processing time for triggering the resource selection indicating a time before the first resource when the first UE may be capable of cancelling transmission of the sidelink transmission in the first resource and performing the resource selection.

In some examples of the method, apparatuses, and non-transitory computer-readable medium described herein, performing the resource selection may include operations, features, means, or instructions for performing the resource selection to select the second resource based on receiving the conflict indication at least a threshold amount of time prior to the first resource.

In some examples of the method, apparatuses, and non-transitory computer-readable medium described herein, reporting, from a PHY layer at the first UE to a MAC layer at the first UE, a NACK message based on receiving the conflict indication.

A method for wireless communication at a first UE is described. The method may include transmitting a control message indicating reservation of a first resource of a sidelink channel for a sidelink transmission, receiving, from a second UE, a conflict indication indicating a reservation conflict for the first resource based on the control message, and transmitting the sidelink transmission using the first resource.

An apparatus for wireless communication at a first UE is described. The apparatus may include a processor, memory coupled with the processor, and instructions stored in the memory. The instructions may be executable by the processor to cause the apparatus to transmit a control message indicating reservation of a first resource of a sidelink channel for a sidelink transmission, receive, from a second UE, a conflict indication indicating a reservation conflict for the first resource based on the control message, and transmit the sidelink transmission using the first resource.

Another apparatus for wireless communication at a first UE is described. The apparatus may include means for transmitting a control message indicating reservation of a first resource of a sidelink channel for a sidelink transmission, means for receiving, from a second UE, a conflict indication indicating a reservation conflict for the first resource based on the control message, and means for transmitting the sidelink transmission using the first resource.

A non-transitory computer-readable medium storing code for wireless communication at a first UE is described. The code may include instructions executable by a processor to transmit a control message indicating reservation of a first resource of a sidelink channel for a sidelink transmission, receive, from a second UE, a conflict indication indicating a reservation conflict for the first resource based on the control message, and transmit the sidelink transmission using the first resource.

In some examples of the method, apparatuses, and non-transitory computer-readable medium described herein, transmitting the sidelink transmission may include operations, features, means, or instructions for transmitting the sidelink transmission using the first resource based on a remaining PDB for a packet in the sidelink transmission being less than a threshold value corresponding to a time when the conflict indication may be received.

Some examples of the method, apparatuses, and non-transitory computer-readable medium described herein may further include operations, features, means, or instructions for transmitting the sidelink transmission using the first resource based on a priority associated with the sidelink transmission being greater than or equal to a priority threshold value.

Some examples of the method, apparatuses, and non-transitory computer-readable medium described herein may further include operations, features, means, or instructions for transmitting the sidelink transmission using the first resource based on a conflict indication percentage during a time duration being greater than or equal to a threshold percentage.

Some examples of the method, apparatuses, and non-transitory computer-readable medium described herein may further include operations, features, means, or instructions for transmitting the sidelink transmission using the first resource based on a conflict indication percentage for a last quantity of transmitted control messages being greater than or equal to a threshold percentage.

Some examples of the method, apparatuses, and non-transitory computer-readable medium described herein may further include operations, features, means, or instructions for transmitting the sidelink transmission using the first resource based on a quantity of received conflict indications for consecutive resource reservations being greater than or equal to a threshold.

Some examples of the method, apparatuses, and non-transitory computer-readable medium described herein may further include operations, features, means, or instructions for transmitting an indication of a processing time for triggering resource selection indicating a time before the first resource when the first UE may be capable of cancelling transmission of the sidelink transmission in the first resource and performing the resource selection.

### BRIEF DESCRIPTION OF THE DRAWINGS

FIG. 1 illustrates an example of a wireless communications system that supports resource re-selection based on pre-conflict indication in accordance with aspects of the present disclosure.

FIG. 2 illustrates an example of a wireless communications system that supports resource re-selection based on pre-conflict indication in accordance with aspects of the present disclosure.

FIG. 3 illustrates an example of a selection scheme that supports resource re-selection based on pre-conflict indication in accordance with aspects of the present disclosure.

FIGS. 4A and 4B illustrate examples of timelines that support resource re-selection based on pre-conflict indication in accordance with aspects of the present disclosure.

FIGS. 5 and 6 illustrate examples of a process flows that support resource re-selection based on pre-conflict indication in accordance with aspects of the present disclosure.

FIGS. 7 and 8 show block diagrams of devices that support resource re-selection based on pre-conflict indication in accordance with aspects of the present disclosure.

FIG. 9 shows a block diagram of a communications manager that supports resource re-selection based on pre-conflict indication in accordance with aspects of the present disclosure.

FIG. 10 shows a diagram of a system including a device that supports resource re-selection based on pre-conflict indication in accordance with aspects of the present disclosure.

FIGS. 11 through 14 show flowcharts illustrating methods that support resource re-selection based on pre-conflict indication in accordance with aspects of the present disclosure.

### DETAILED DESCRIPTION

In some wireless communications systems, a first user equipment (UE) and a second UE may communicate using sidelink communications. In resource allocation mode 2, the first UE may reserve one or more resources (e.g., time and frequency resources) for a future sidelink transmission to the second UE. For example, the first UE may transmit control signaling to at least the second UE indicating the one or more reserved resources for the future sidelink transmission by the first UE. However, the second UE may determine that there is a reservation conflict with the first UE and another UE (e.g., the second UE, or any other UE) for at least one of the one or more reserved resources. That is, the first UE and the other UE may be reserving the same resource of a sidelink channel for a sidelink transmission, which may cause interference if both UEs transmit in the same resource.

According to the techniques described herein, a first UE (e.g., a sidelink UE) may receive a pre-conflict indication from a second UE (e.g., a sidelink UE) indicative of a conflicting resource, and the first UE may determine whether to perform resource re-selection, or the first UE may disregard the pre-conflict indication. That is, based on one or more factors (e.g., based on packet delay budget (PDB) information, priority information, a number of pre-conflict indications, or any combination of these), the first UE may determine whether to select a different resource from the conflicting resource for a sidelink transmission, or the first UE may transmit in the conflicting resource for the sidelink transmission. To determine whether to perform resource re-selection, the first UE may compare a duration between the received pre-conflict indication and the conflicting resource to a threshold amount of time. For example, the first UE may perform resource re-selection if the pre-conflict indication is received at least the threshold amount of time prior to the conflicting resource. In some other examples, the first UE may refrain from performing resource re-selection, and in some cases may instead perform resource selection at a later time, if the first UE receives the pre-conflict indication with less than the threshold amount of time prior to the conflicting resource. In such cases, a physical (PHY) layer of the first UE may report a negative acknowledgement (NACK) message to a medium access control (MAC) layer of the first UE. In some cases, the first UE may report to at least the second UE a duration for performing or triggering resource re-selection (e.g., a processing time at the first UE) to select the different resource. The second UE may thus be able to account for the processing time when determining when to transmit the pre-conflict indication to the first UE (e.g., the second UE may transmit the pre-conflict indication earlier or later based on the processing time).

Aspects of the disclosure are initially described in the context of wireless communications systems. Aspects of the disclosure are further illustrated by and described with reference to a selection scheme, a timeline, process flows, apparatus diagrams, system diagrams, and flowcharts that relate to resource re-selection based on pre-conflict indication.

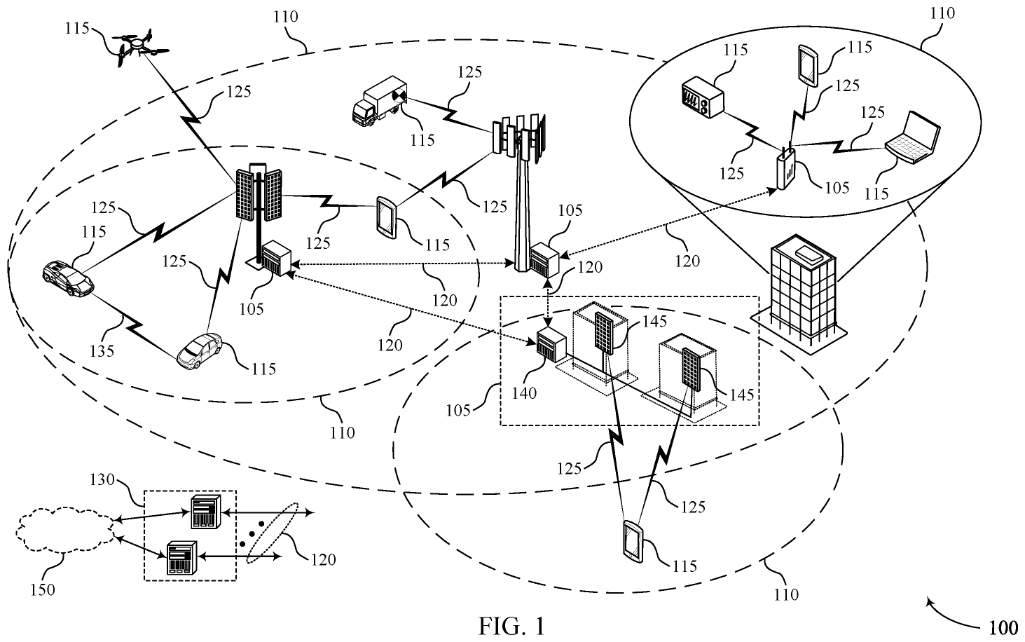

FIG. 1 illustrates an example of a wireless communications system 100 that supports resource re-selection based on pre-conflict indication in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined PHY layer structure for supporting the communication links 125. For example, a carrier used for a communication link 125 may include a portion of a radio frequency spectrum band (e.g., a bandwidth part (BWP)) that is operated according to one or more PHY layer channels for a given radio access technology (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing (SCS) are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include an SCS (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ a may represent the maximum supported SCS, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on SCS. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the SCS or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the PHY layer, transport channels may be mapped to physical channels.

A first UE may transmit a control message indicating reservation of a first resource of a sidelink channel for a sidelink transmission to a second UE. The first UE may receive a pre-conflict indication for the first resource indicating that a different UE (e.g., the second UE, or any other UE) has reserved the first resource for a transmission. In some cases, the first UE may disregard the pre-conflict indication, or may not disregard the conflict indication based on one or more factors. In cases where the first UE does not disregard the pre-conflict indication, the first UE may perform resource re-selection to select a second resource for the sidelink transmission if the first UE receives the conflict indication at least a threshold amount of time prior to the first resource, and may transmit using the second resource. Otherwise, the first UE may report a NACK message from a PHY layer to a MAC layer, and may perform resource re-selection at a later time.

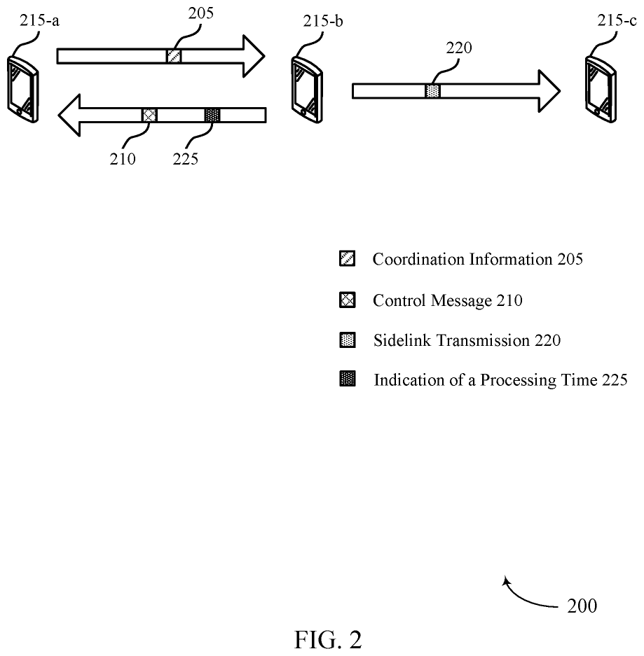

FIG. 2 illustrates an example of a wireless communications system 200 that supports techniques for resource re-selection based on pre-conflict indication in accordance with aspects of the present disclosure. The wireless communications system 200 may implement or be implemented by aspects of the wireless communications system 100 as described with reference to FIG. 1. For example, the wireless communications system 200 may include UEs 215, which may be examples of UEs 115 as described herein. The wireless communications system 200 may support improvements to interference, processing, power consumption, and more efficient utilization of communication resources, among other benefits.

The wireless communications system 200 may support sidelink communications between various UEs 215. For example, a UE 215 may transmit over a sidelink connection to any other UE 215 using one or more resources. The wireless communications system 200 may not be limited to the four example UEs 215 as illustrated in the wireless communications system 200, and may support one, two, three, four, or more UEs 215 in communication.

To transmit over a sidelink connection, UE 215-b (e.g., in a mode 2) may reserve one or more resources for the transmission by performing a resource selection or allocation procedure, and transmitting control signaling (e.g., which may include sidelink control information (SCI)) to other UEs 215 indicating the reserved one or more resources. Mode 2 may refer to configurations where UEs 215, rather than base stations, reserve such resources. To help UE 215-b avoid resource collisions (e.g., avoid reserving a resource that may be reserved by another UE 215, which may be referred to as a resource conflict) and improve resource allocation, UE 215-a, among other UEs 215, may support inter-UE coordination. That is, UE 215-a may generate and transmit coordination information 205 to UE 215-b. For example, UE 215-a may transmit coordination information 205 to indicate a preferred resource for the transmission by UE 215-b, a non-preferred resource for the transmission by UE 215-b, a conflict indication, or any combination of these. In some cases, the conflict indication may indicate a conflict that has already occurred (e.g., two UEs 215 may have transmitted on the same or overlapping resources, which may be referred to as a direct collision, or may have transmitted in the same slot and thus could not hear each other (e.g., the UEs 215 may be transmitting at the same time, such as in a same slot, but may not be receiving in that slot, and thus the UEs 215 may not receive each other's transmission), which may be referred to as a half-duplex constraint. In some other cases, the conflict indication may be a pre-conflict indication, and may indicate a conflict that is expected. For example, two UEs 215 may be reserving the same or overlapping resources in a future slot, or may be reserving resources in the same slot and thus will not hear each other (e.g., the UEs 215 may be transmitting reservation signaling at the same time, such as in a same slot, but may not be receiving in that slot, and thus the UEs 215 may not receive each other's reservation) which may result in an expected resource conflict. In some cases, such UEs 215 may be peer UEs 215 in unicast communications, or may belong to the same UE group in groupcast communications. UE 215-a may determine an expected conflict by comparing at least two reserved resources indicated in control signaling to UE 215-a. For example, UE 215-a may compare a first reserved resource (e.g., reserved by UE 215-b for sidelink transmission 220) indicated in received control message 210 (e.g., which may include SCI) with a second reserved resource (e.g., reserved by UE 215-a, or reserved by any other UE 215, including those not illustrated) indicated in other received control signaling from other UEs 215 (e.g., which may include SCI).

UEs 215 may support one or more schemes for inter-UE coordination in mode 2. For example, a first inter-UE coordination scheme (e.g., scheme 1) may specify that coordination information 205 transmitted from UE 215-a to UE 215-b may include a set of preferred resources, non-preferred resources, or both for sidelink transmission 220 by UE 215-b. Scheme 1 may specify down-selection between the preferred resource set and the non-preferred resource set, and whether to include additional information other than indicating times or frequencies of the resources within the resource set in the coordination information. In some other examples, a second inter-UE coordination scheme (e.g., scheme 2) may specify that coordination information 205 transmitted from UE 215-a to UE 215-b may include an expected, potential, or detected resource conflict on resources indicated by control message 210, which may include SCI, for sidelink transmission 220 by UE 215-b. Scheme 2 may specify down-selection between the expected or potential conflict and the detected resource conflict.

Transmitting sidelink transmission 220 on a reserved but conflicting future resource may be undesirable for UE 215-b, as this may cause interference. According to the techniques described herein, to avoid the potential conflict in the future reserved resource by UE 215-b as indicated by a pre-conflict indication in coordination information 205, UE 215-b may perform resource re-selection or re-evaluation based on the pre-conflict indication and according to a timeline triggered by receiving the coordination information 205.

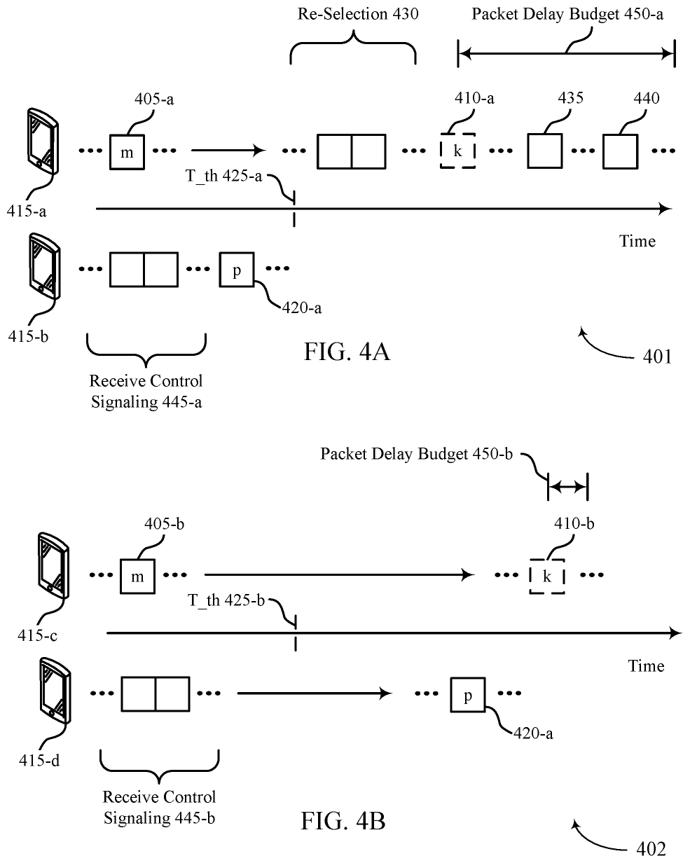

In some examples, UE 215-b may receive coordination information 205, which may include a pre-conflict indication, from UE 215-a indicative of a conflicting resource, and UE 215-b may determine whether to perform resource re-selection. UE 215-b may determine whether to perform resource re-selection by comparing a duration between the received coordination information 205 including the pre-conflict indication and the conflicting resource to a threshold amount of time. For example, UE 215-b may perform resource re-selection if coordination information 205 including the pre-conflict indication is received at least the threshold amount of time prior to the conflicting resource. In some other examples, UE 215-b may refrain from performing resource re-selection, and in some cases may instead perform resource selection at a later time, if UE 215-b receives the coordination information 205 including the pre-conflict indication with less than the threshold amount of time prior to the conflicting resource. In such cases, a PHY layer of UE 215-b may report a NACK message to a MAC layer of UE 215-b. Such aspects may be further described in at least FIG. 4.

In some examples, UE 215-b may receive coordination information 205, which may include a pre-conflict indication, from UE 215-a indicative of a conflicting resource, and UE 215-b may disregard the pre-conflict indication. UE 215-b may disregard the pre-conflict indication if a remaining PDB for a packet in reserved sidelink transmission 220 is smaller than a threshold, if a reserved transmission (e.g., sidelink transmission 220 using reserved resources) has a priority that is higher than a priority threshold, if UE 215-b has received a high number of pre-conflict indications, or any combination thereof. Such aspects may be further described in at least FIG. 4.

In some examples, UE 215-b may report to at least UE 215-a a duration for performing or triggering resource re-selection (e.g., indication of a processing time 225 at UE 215-b) to select the different resource. UE 215-a may thus be able to account for the processing time when determining when to transmit coordination information 205 including the pre-conflict indication to UE 215-a (e.g., UE 215-a may transmit coordination information 205 earlier or later based on the indication of a processing time 225). Such aspects may be further described in at least FIG. 4.

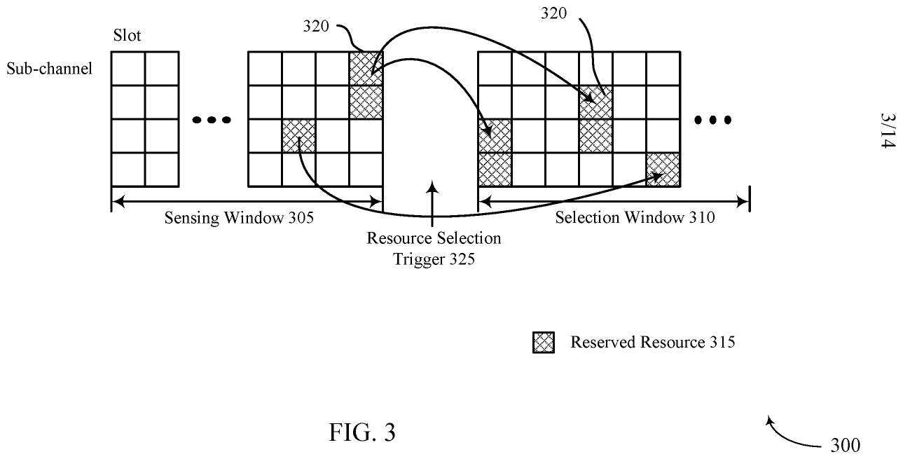

FIG. 3 illustrates an example of a transmission scheme 300 that supports techniques for resource re-selection based on pre-conflict indication in accordance with aspects of the present disclosure. The transmission scheme 300 may implement or be implemented by aspects of the wireless communications system 100, wireless communications system 200, or both, as described with reference to FIGS. 1 and 2. For example, the transmission scheme 300 may illustrate sensing and resource selection at a UE, which may be an example of corresponding devices described with reference to FIGS. 1 and 2.

UEs may communicate with other UEs over sidelink communication links. In Mode 2, UEs may perform resource allocation (e.g., resource reservation) to reserve resources for future transmissions (e.g., for sidelink communications, V2X communications, or the like) according to transmission scheme 300.

A UE may identify available resources during selection window 310, which may be a future resource selection window, based on sidelink sensing during sensing window 305. During sensing window 305, the UE may monitor or decode sidelink transmissions for resource reservation (e.g., which may include SCI) from other UEs in a sidelink resource pool. The decoded sidelink transmissions may include reservation information (e.g., reserved resources 315) from the other UEs. For example, the UE may identify reserved resource 320 in a received sidelink transmission, indicating that reserved resource 320 is reserved for a transmission by another UE. The UE may determine a reference signal received power (RSRP) with which the sidelink transmissions for resource reservation are received. The UE may determine that a resource is not available if a measured RSRP of a received sidelink transmission for resource reservation during sensing window 305 is greater than an RSRP threshold, and if the resource is reserved as indicated by the received sidelink transmission. For example, the UE may determine that reserved resource 320 is not available due to receiving an associated sidelink transmission for resource reservation with an RSRP greater than the RSRP threshold.

The UE may identify a resource selection trigger 325, and may perform resource selection during selection window 310. The UE may select from any of the available resources during the selection window 310 (e.g., randomly select from the available resources), but may refrain from selecting unavailable resources. For example, the UE may refrain from selecting the reserved resource 320. The UE may transmit signaling in a selected resource indicating one or more reserved future resources that are identified to be available for one or more future transmissions by the UE. Such reservation signaling may include or be included in SCI. Other UEs may receive the reservation signaling and perform resource selection according to transmission scheme 300.

In some cases, resource selection trigger 325 may occur at a slot (e.g., time instance) n, and sensing window 305 may be defined by a time interval in relation to n (e.g., [n−T0, n−T_{proc,0}], where T_{proc,0} may be {1, 1, 2,4} slots for {15, 30, 60, 120} kilohertz (KHz) SCS, respectively. In some cases, resource selection window may start at a slot (e.g., time instance) (n+T1), where T1≥0, and may end at a slot (e.g., time instance) (n+T2). In some cases, TO may be configured as 1100 ms or 100 ms, T1 may be determined by the UE and may be subject to T1≤T_{proc,1} where T_{proc,1} may be {3, 5, 9, 17} slots for {15, 30, 60, 120} KHz SCS, respectively, and T2 may be subject to T2≥T2ₘᵢₙ, where T2ₘᵢₙ may be less than or equal to a remaining PDB (e.g., for a packet for a sidelink transmission).

In some cases, a reserved resource for a future transmission by a UE may be taken over by another UE having higher transmission priority using the same reserved resource, which may be referred to as pre-emption. Thus, the UE may perform a resource re-evaluation procedure to ensure that the reserved resource is still available for transmission. For re-evaluation of a reserved resource contained in a slot k as reserved in reservation signaling at a slot m, where k≥m, the UE may sense for candidate resources for re-evaluation at least at a slot m−T3, where T3=T_{proc,1}. If re-selection is triggered due to pre-emption, the re-selection procedure for a reserved but pre-empted resource for transmission in a slot m may not be triggered at a slot greater than m−T3. In some cases, the UE may include sensing information from a time prior to m−T3−T_{proc,0} for pre-emption and re-evaluation sensing (e.g., checking) at least at the slot m−T3.

FIGS. 4A and 4B illustrate examples of timeline 401 and timeline 402, respectively, that support techniques for resource re-selection based on pre-conflict indication in accordance with aspects of the present disclosure. The timeline 401 and timeline 402 may implement or be implemented by aspects of the wireless communications system 100, wireless communications system 200, or both, as described with reference to FIGS. 1 and 2. For example, timeline 401 and timeline 402 may illustrate resource re-selection timelines at UEs 415, which may be examples of corresponding devices described with reference to FIGS. 1 and 2.

Regarding FIG. 4A or 4B, UE 415-a or UE 415-c, respectively, may transmit control (e.g., reservation) signaling to UE 415-b or UE 415-d (e.g., received at slots for receiving control signaling 445), respectively, (e.g., which may include SCI) at slot m 405 for a reserved future resource for a transmission at slot k 410. UE 415-a or UE 415-c, respectively, may receive a pre-conflict indication from UE 415-b or UE 415-d, respectively, at a slot p. 420. For example, when UE 415-a and another UE (not shown) are reserving conflicting resources at the same time, UE 415-b may be able to detect the conflict (e.g., UE 415-b may be able to decode control channels transmitted by each of UE 415-a and the other UE, but UE 415-a and the other UE may be unable to identify the conflict due to UE 415-a and the other UE reserving the same resources at the same time), and transmit a conflict indication (e.g., a pre-conflict indication) to UE 415-a or the other UE. In some cases, two UEs may not transmit a conflict indication to two conflicting UEs for a same conflict. The pre-conflict indication may indicate a conflict for the resource at slot k 410. That is, the pre-conflict indication may indicate that the other UE (e.g., UE 415-b, UE 415-d, or any other UE) may also be reserving the resource at slot k 410 for a transmission. FIG. 4A may illustrate a timeline 401 where UE 415-a may perform resource re-selection for the transmission (e.g., transmits in a different slot than slot k 410-a) based on one or more factors as described herein. FIG. 4B may illustrate a timeline 402 where UE 415-c may not perform resource re-selection, and also may not transmit in slot k 410-b, based on the one or more factors as described herein. In both FIG. 4A and FIG. 4B, UE 415-a or UE 415-c, respectively, may not perform resource re-selection, and may transmit in slot k 410 based on the one or more factors as described herein.

In FIG. 4A, UE 415-a may perform resource re-selection for the transmission based on comparing a duration between the received pre-conflict indication and the conflicting resource to a threshold amount of time T_th 425, which may be pre-determined or pre-configured at UE 415-a (e.g., via control signaling, or determined by UE 415-a). That is, UE 415-a may perform resource re-selection for the transmission if k−p≥T_th. T_th may include a number of slots depending on an SCS configuration for the transmission. In some examples, T_th may be defined as T_th=T3, where T3=T_{proc,1} as defined previously. In some other examples, T_th may be defined as T_th=T3+T_{proc,0}. In some other examples, T_th may be defined as T_th=T3+T_{proc,2}, where T_{proc,2} may be a parameter specified to accommodate for a processing time by UE 415-a for the received pre-conflict indication. In some other examples, UE 415-a may determine T_th based on an implementation or processing capability of UE 415-a. That is, different conflicting UEs 415 may determine different T_th values. In some cases, T_th may be bounded by a specified lower bound value, upper bound value, or both, and the exact threshold time of T_th may be determined by UE 415-a. The specified upper bound value, lower bound value, or both may be pre-configured at UE 415-a, or UE 415-a may receive signaling (e.g., control signaling) indicating the specified upper bound value, lower bound value, or both. In some other cases, T_th may not be bounded by a lower bound value, upper bound value, or both. That is, threshold time T_th may be purely up to UE 415-a, and there may be no predetermined upper or lower bound for the threshold time T_th.

Upon performing resource re-selection at 430, UE 415-a may transmit control signaling (e.g., including SCI) at slot 435 to other UEs 415 indicating the re-selected, reserved resource (e.g., a resource at a time different from slot k 410) for the transmission. At slot 440, UE 415-a may transmit the transmission using the re-selected, reserved resource.

In FIG. 4B, UE 415-a may refrain from performing resource re-selection for the transmission based on the comparison, and in some cases, may perform resource selection (e.g., resource re-selection) at a later time. That is, if k−p<T_th, UE 415-a may not transmit in slot k 410-a, and UE 415-a may report a NACK message, via a PHY layer at UE 415-a, to a MAC layer at UE 415-a, indicating that the transmission in slot k 410-a was unsuccessful.

In some cases, UE 415-a or UE 415-c may disregard a received pre-conflict indication if one or more conditions are met, and thus transmit in reserved slot k 410 anyway. Conversely, UE 415-a or UE 415-c may not disregard the received pre-conflict indication if such conditions are not met, or if the opposite of such conditions are met, or the like. For example, UE 415-a or UE 415-c may disregard the pre-conflict indication if a remaining PDB for a packet for the transmission is less than a threshold value, which may be pre-determined or pre-configured at UE 415-a or UE 415-c (e.g., via control signaling). That is, UE 415-a or UE 415-c may not have enough time to perform resource re-selection 430, and may transmit in slot k 410 irrespective of the received pre-conflict indication. For example, if a remaining PDB for a packet for the transmission at slot k 410-a is PDB 450-a, then UE 415-a may not disregard the pre-conflict indication and may be able to transmit at slot 440. However, if a remaining PDB for a packet for the transmission at slot k 410-b is PDB 450-b, then UE 415-c may disregard the pre-conflict indication due to not having enough time (e.g., not having a large enough PDB) to transmit in a potential future re-selected resource slot.

In some other examples, UE 415-a or UE 415-c may disregard the pre-conflict indication if a transmission priority associated with the transmission in slot k 410 is greater than a threshold priority. This priority threshold may be pre-determined or pre-configured at the UE 415-a or UE 415-c (e.g., via control signaling).

In some other examples, UE 415-a or UE 415-c may disregard the pre-conflict indication if such UEs 415 have received a high number of pre-conflict indications, as such UEs may not be able to successfully perform resource re-selection for a transmission if such UEs act based on each of the high number of pre-conflict indications. In some cases, UE 415-a or UE 415-c may disregard the pre-conflict indication if, out of a total quantity of resource reservations made by UE 415-a or UE 415-c in control messages (e.g., during a time window or duration, or out of a last quantity N of transmitted control messages making reservations, where N may be pre-determined or pre-configured, such as via control signaling), UE 415-a or UE 415-c has received pre-conflict indications from UE 415-b or UE 415-d, respectively, for at least x percent of the total quantity of resource reservations made, where x may be pre-determined or pre-configured (e.g., via control signaling). In some other cases, UE 415-a or UE 415-c may disregard the pre-conflict indication if UE 415-a or UE 415-c has received pre-conflict indications for at least M consecutive reservations, where M may be pre-determined or preconfigured (e.g., via control signaling).

In some cases, UE 415-a or UE 415-c may indicate a processing time to UE 415-b or UE 415-d, respectively, for resource re-selection 430 so UE 415-b or UE 415-d, respectively, may account for the processing time and transmit a pre-conflict indication with adequate time (e.g., early enough) for UE 415-a or UE 415-c to perform the resource re-selection 430. UE 415-a or UE 415-c may indicate the processing time in signaling reserving resources for future transmissions (e.g., in control signaling, which may include SCI, transmitted at slot 435). The indicated processing time may be based on or related to capability information of the UE 415-a or UE 415-c. In some examples, the processing time may be equivalent to the value of the threshold parameter T_th 425, that is may include or be defined by a time duration between slot p. 420 and slot k 410, or may be a different threshold relative to slot k.

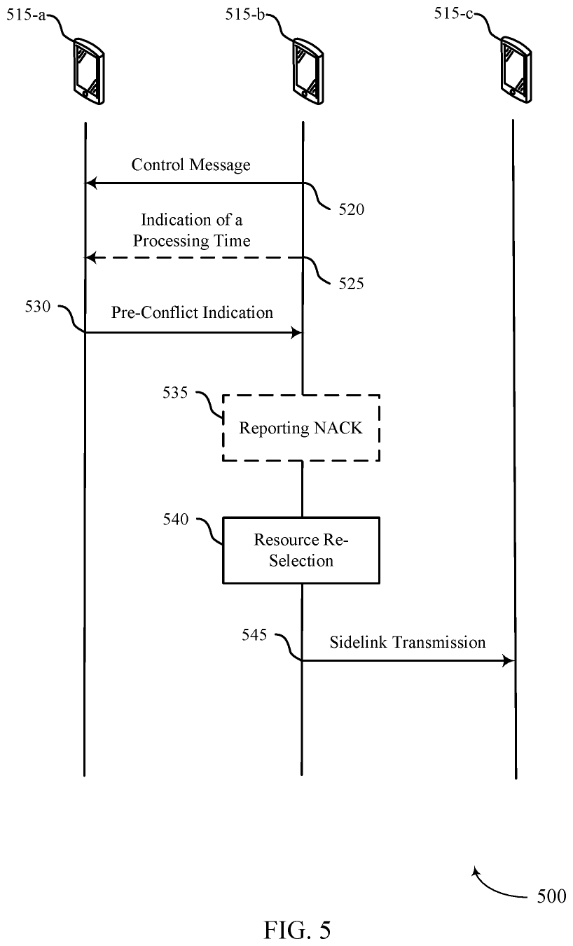

FIG. 5 illustrates an example of a process flow 500 that supports techniques for resource re-selection based on pre-conflict indication in accordance with aspects of the present disclosure. The process flow 500 may implement or be implemented by aspects of the wireless communications system 100, wireless communications system 200, or a combination of these, as described with reference to FIG. 1 and FIG. 2. In some examples, the process flow 500 may include example operations associated with one or more UEs 515, which may be examples of corresponding devices described with reference to FIGS. 1, 2, and 4. In the following description of the process flow 500, the operations between the UEs 515 may be performed in a different order than the example order shown, or the operations performed by the UEs 515 may be performed in different orders or at different times. Some operations may also be omitted from the process flow 500, and other operations may be added to the process flow 500.

At 520, UE 515-b may transmit a control message indicating reservation of a first resource of a sidelink channel for a sidelink transmission.

At 525, UE 515-b may transmit an indication of a processing time for triggering resource selection indicating a time before the first resource when UE 515-b may be capable of cancelling transmission of the sidelink transmission in the first resource and performing the resource selection.

At 530, UE 515-b may receive, from UE 515-a, a conflict indication indicating a reservation conflict for the first resource based at least in part on the control message.

At 535, UE 515-b may report, from a PHY layer at UE 515-b to a MAC layer at UE 515-b, a NACK message based at least in part on receiving the conflict indication. UE 515-b may perform resource selection (e.g., resource re-selection) at a later time.

At 540, UE 515-b may perform the resource selection to select a second resource based at least in part on receiving the conflict indication. In some examples, UE 515-b may perform the resource selection to select the second resource based at least in part on receiving the conflict indication at least a threshold amount of time (e.g., T_th) prior to the first resource.

At 545, UE 515-b may transmit the sidelink transmission using the second resource. In some examples, UE 515-b may transmit the sidelink transmission using the second resource based on a remaining PDB for a packet in the sidelink transmission being greater than or equal to a threshold value corresponding to a time when the conflict indication is received. In some examples, UE 515-b may transmit the sidelink transmission using the second resource based on a priority associated with the sidelink transmission being less than a priority threshold value. In some examples, UE 515-b may transmit the sidelink transmission using the second resource based on a conflict indication percentage during a time duration being less than a first threshold percentage. In some examples, UE 515-b may transmit the sidelink transmission using the second resource based on a conflict indication percentage for a last quantity of transmitted control messages being less than a second threshold percentage. In some examples, UE 515-b may transmit the sidelink transmission using the second resource based on a quantity of received conflict indications for consecutive resource reservations being less than a threshold.

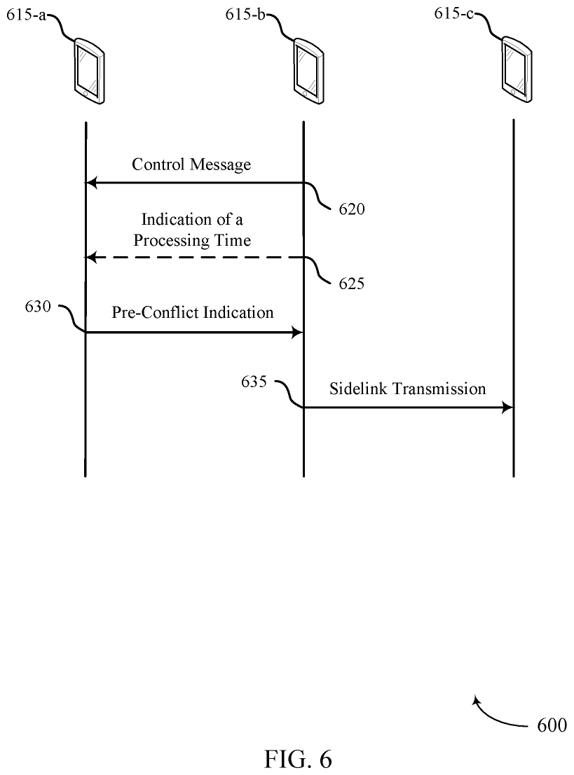

FIG. 6 illustrates an example of a process flow 600 that supports techniques for resource re-selection based on pre-conflict indication in accordance with aspects of the present disclosure. The process flow 600 may implement or be implemented by aspects of the wireless communications system 100, wireless communications system 200, or a combination of these, as described with reference to FIG. 1 and FIG. 2. In some examples, the process flow 600 may include example operations associated with one or more UEs 615, which may be examples of corresponding devices described with reference to FIGS. 1, 2, 4, and 5. In the following description of the process flow 600, the operations between the UEs 615 may be performed in a different order than the example order shown, or the operations performed by the UEs 615 may be performed in different orders or at different times. Some operations may also be omitted from the process flow 600, and other operations may be added to the process flow 600.

At 620, UE 615-b may transmit a control message indicating reservation of a first resource of a sidelink channel for a sidelink transmission.

At 625, UE 615-b may transmit an indication of a processing time for triggering resource selection indicating a time before the first resource when the first UE is capable of cancelling transmission of the sidelink transmission in the first resource and performing the resource selection.

At 630, UE 615-b may receive, from UE 615-a, a conflict indication indicating a reservation conflict for the first resource based on the control message.

At 635, UE 615-b may transmit the sidelink transmission using the first resource. In some examples, UE 615-b may transmit the sidelink transmission using the first resource based on a remaining PDB for a packet in the sidelink transmission being less than a threshold value corresponding to a time when the conflict indication is received. In some examples, UE 615-b may transmit the sidelink transmission using the first resource based on a priority associated with the sidelink transmission being greater than or equal to a priority threshold value. In some examples, UE 615-b may transmit the sidelink transmission using the first resource based on a conflict indication percentage during a time duration being greater than or equal to a first threshold percentage. In some examples, UE 615-b may transmit the sidelink transmission using the first resource based on a conflict indication percentage for a last quantity of transmitted control messages being greater than or equal to a second threshold percentage. In some examples, UE 615-b may transmit the sidelink transmission using the first resource based on a quantity of received conflict indications for consecutive resource reservations being greater than or equal to a threshold.

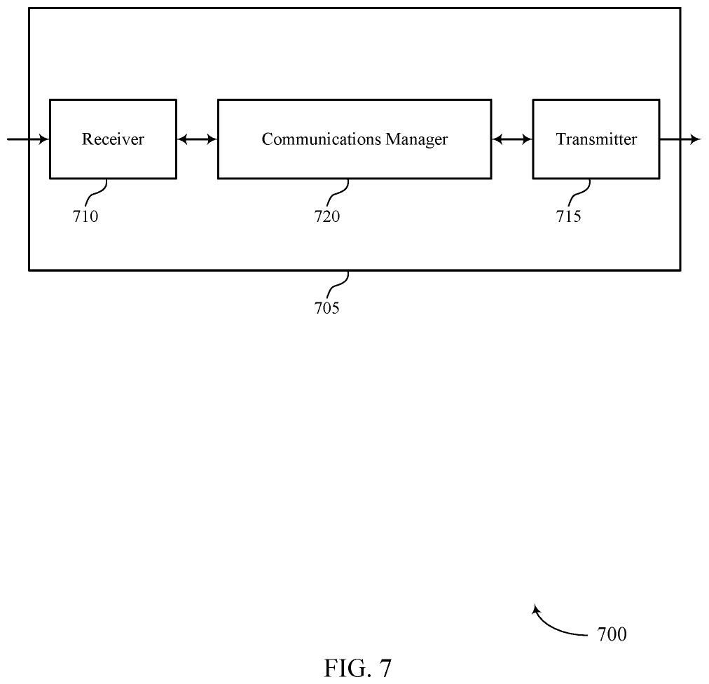

FIG. 7 shows a block diagram 700 of a device 705 that supports resource re-selection based on pre-conflict indication in accordance with aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to resource re-selection based on pre-conflict indication). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to resource re-selection based on pre-conflict indication). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of resource re-selection based on pre-conflict indication as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 720 may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communication at a first UE in accordance with examples as disclosed herein. For example, the communications manager 720 may be configured as or otherwise support a means for transmitting a control message indicating reservation of a first resource of a sidelink channel for a sidelink transmission. The communications manager 720 may be configured as or otherwise support a means for receiving, from a second UE, a conflict indication indicating a reservation conflict for the first resource based on the control message. The communications manager 720 may be configured as or otherwise support a means for performing resource selection to select a second resource based on receiving the conflict indication. The communications manager 720 may be configured as or otherwise support a means for transmitting the sidelink transmission using the second resource.

Additionally or alternatively, the communications manager 720 may support wireless communication at a first UE in accordance with examples as disclosed herein. For example, the communications manager 720 may be configured as or otherwise support a means for transmitting a control message indicating reservation of a first resource of a sidelink channel for a sidelink transmission. The communications manager 720 may be configured as or otherwise support a means for receiving, from a second UE, a conflict indication indicating a reservation conflict for the first resource based on the control message. The communications manager 720 may be configured as or otherwise support a means for transmitting the sidelink transmission using the first resource.

By including or configuring the communications manager 720 in accordance with examples as described herein, the device 705 (e.g., a processor controlling or otherwise coupled to the receiver 710, the transmitter 715, the communications manager 720, or a combination thereof) may support techniques for reduced processing, reduced power consumption, and more efficient utilization of communication resources.

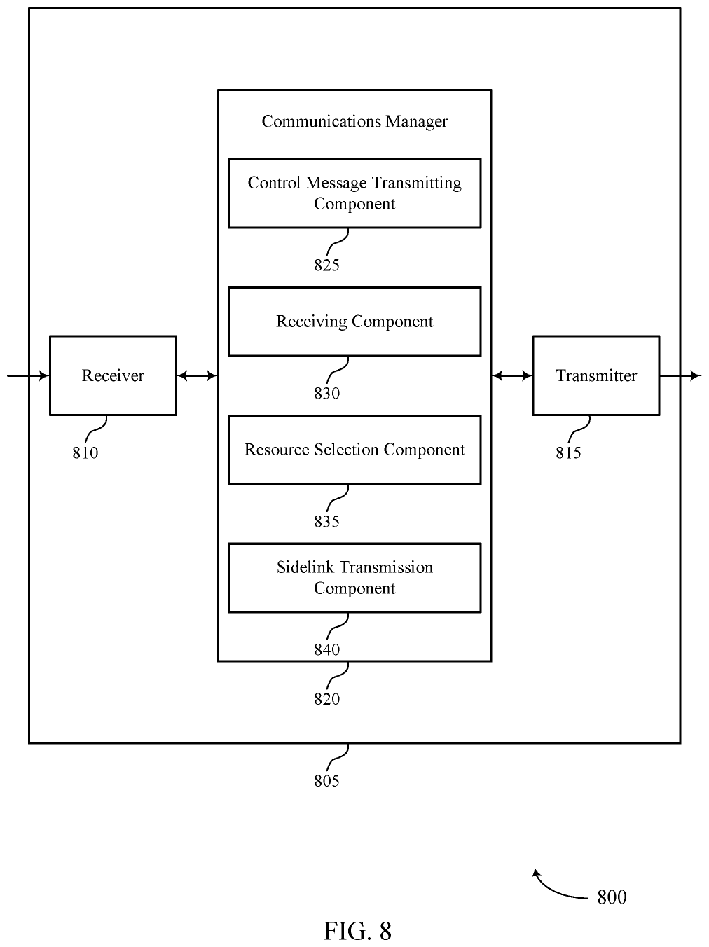

FIG. 8 shows a block diagram 800 of a device 805 that supports resource re-selection based on pre-conflict indication in accordance with aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to resource re-selection based on pre-conflict indication). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to resource re-selection based on pre-conflict indication). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of resource re-selection based on pre-conflict indication as described herein. For example, the communications manager 820 may include a control message transmitting component 825, a receiving component 830, a resource selection component 835, a sidelink transmission component 840, or any combination thereof. The communications manager 820 may be an example of aspects of a communications manager 720 as described herein. In some examples, the communications manager 820, or various components thereof, may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communication at a first UE in accordance with examples as disclosed herein. The control message transmitting component 825 may be configured as or otherwise support a means for transmitting a control message indicating reservation of a first resource of a sidelink channel for a sidelink transmission. The receiving component 830 may be configured as or otherwise support a means for receiving, from a second UE, a conflict indication indicating a reservation conflict for the first resource based on the control message. The resource selection component 835 may be configured as or otherwise support a means for performing resource selection to select a second resource based on receiving the conflict indication. The sidelink transmission component 840 may be configured as or otherwise support a means for transmitting the sidelink transmission using the second resource.

Additionally or alternatively, the communications manager 820 may support wireless communication at a first UE in accordance with examples as disclosed herein. The control message transmitting component 825 may be configured as or otherwise support a means for transmitting a control message indicating reservation of a first resource of a sidelink channel for a sidelink transmission. The receiving component 830 may be configured as or otherwise support a means for receiving, from a second UE, a conflict indication indicating a reservation conflict for the first resource based on the control message. The sidelink transmission component 840 may be configured as or otherwise support a means for transmitting the sidelink transmission using the first resource.

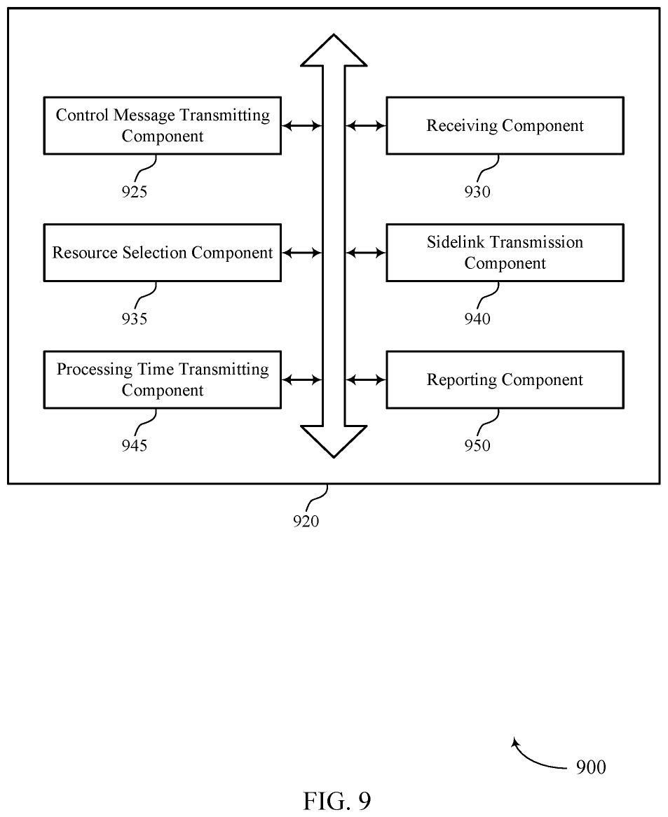

FIG. 9 shows a block diagram 900 of a communications manager 920 that supports resource re-selection based on pre-conflict indication in accordance with aspects of the present disclosure. The communications manager 920 may be an example of aspects of a communications manager 720, a communications manager 820, or both, as described herein. The communications manager 920, or various components thereof, may be an example of means for performing various aspects of resource re-selection based on pre-conflict indication as described herein. For example, the communications manager 920 may include a control message transmitting component 925, a receiving component 930, a resource selection component 935, a sidelink transmission component 940, a processing time transmitting component 945, a reporting component 950, or any combination thereof. Each of these components may communicate, directly or indirectly, with one another (e.g., via one or more buses).

The communications manager 920 may support wireless communication at a first UE in accordance with examples as disclosed herein. The control message transmitting component 925 may be configured as or otherwise support a means for transmitting a control message indicating reservation of a first resource of a sidelink channel for a sidelink transmission. The receiving component 930 may be configured as or otherwise support a means for receiving, from a second UE, a conflict indication indicating a reservation conflict for the first resource based on the control message. The resource selection component 935 may be configured as or otherwise support a means for performing resource selection to select a second resource based on receiving the conflict indication. The sidelink transmission component 940 may be configured as or otherwise support a means for transmitting the sidelink transmission using the second resource.

In some examples, to support performing the resource selection, the resource selection component 935 may be configured as or otherwise support a means for performing the resource selection based on a remaining packet delay budget for a packet in the sidelink transmission being greater than or equal to a threshold value corresponding to a time when the conflict indication is received.

In some examples, to support performing the resource selection, the resource selection component 935 may be configured as or otherwise support a means for performing the resource selection based on a priority associated with the sidelink transmission being less than a priority threshold value.

In some examples, to support performing the resource selection, the resource selection component 935 may be configured as or otherwise support a means for performing the resource selection based on a conflict indication percentage during a time duration being less than a threshold percentage.

In some examples, to support performing the resource selection, the resource selection component 935 may be configured as or otherwise support a means for performing the resource selection based on a conflict indication percentage for a last quantity of transmitted control messages being less than a threshold percentage.

In some examples, to support performing the resource selection, the resource selection component 935 may be configured as or otherwise support a means for performing the resource selection based on a quantity of received conflict indications for consecutive resource reservations being less than a threshold.

In some examples, the processing time transmitting component 945 may be configured as or otherwise support a means for transmitting an indication of a processing time for triggering the resource selection indicating a time before the first resource when the first UE is capable of cancelling transmission of the sidelink transmission in the first resource and performing the resource selection.

In some examples, to support performing the resource selection, the resource selection component 935 may be configured as or otherwise support a means for performing the resource selection to select the second resource based on receiving the conflict indication at least a threshold amount of time prior to the first resource.

In some examples, the reporting component 950 may be configured as or otherwise support a means for reporting, from a PHY layer at the first UE to a MAC layer at the first UE, a NACK message based on receiving the conflict indication.

Additionally or alternatively, the communications manager 920 may support wireless communication at a first UE in accordance with examples as disclosed herein. In some examples, the control message transmitting component 925 may be configured as or otherwise support a means for transmitting a control message indicating reservation of a first resource of a sidelink channel for a sidelink transmission. In some examples, the receiving component 930 may be configured as or otherwise support a means for receiving, from a second UE, a conflict indication indicating a reservation conflict for the first resource based on the control message. In some examples, the sidelink transmission component 940 may be configured as or otherwise support a means for transmitting the sidelink transmission using the first resource.

In some examples, to support transmitting the sidelink transmission, the sidelink transmission component 940 may be configured as or otherwise support a means for transmitting the sidelink transmission using the first resource based on a remaining packet delay budget for a packet in the sidelink transmission being less than a threshold value corresponding to a time when the conflict indication is received.

In some examples, the sidelink transmission component 940 may be configured as or otherwise support a means for transmitting the sidelink transmission using the first resource based on a priority associated with the sidelink transmission being greater than or equal to a priority threshold value.

In some examples, the sidelink transmission component 940 may be configured as or otherwise support a means for transmitting the sidelink transmission using the first resource based on a conflict indication percentage during a time duration being greater than or equal to a threshold percentage.

In some examples, the sidelink transmission component 940 may be configured as or otherwise support a means for transmitting the sidelink transmission using the first resource based on a conflict indication percentage for a last quantity of transmitted control messages being greater than or equal to a threshold percentage.

In some examples, the sidelink transmission component 940 may be configured as or otherwise support a means for transmitting the sidelink transmission using the first resource based on a quantity of received conflict indications for consecutive resource reservations being greater than or equal to a threshold.

In some examples, the processing time transmitting component 945 may be configured as or otherwise support a means for transmitting an indication of a processing time for triggering resource selection indicating a time before the first resource when the first UE is capable of cancelling transmission of the sidelink transmission in the first resource and performing the resource selection.

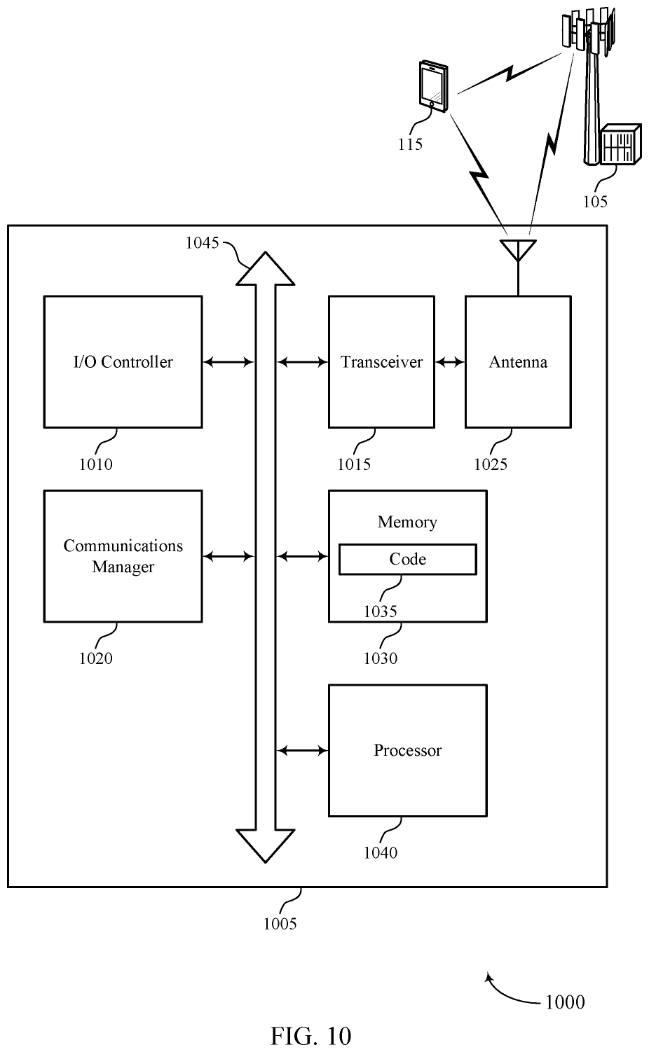

FIG. 10 shows a diagram of a system 1000 including a device 1005 that supports resource re-selection based on pre-conflict indication in accordance with aspects of the present disclosure. The device 1005 may be an example of or include the components of a device 705, a device 805, or a UE 115 as described herein. The device 1005 may communicate wirelessly with one or more base stations 105, UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting resource re-selection based on pre-conflict indication). For example, the device 1005 or a component of the device 1005 may include a processor 1040 and memory 1030 coupled to the processor 1040, the processor 1040 and memory 1030 configured to perform various functions described herein.

The communications manager 1020 may support wireless communication at a first UE in accordance with examples as disclosed herein. For example, the communications manager 1020 may be configured as or otherwise support a means for transmitting a control message indicating reservation of a first resource of a sidelink channel for a sidelink transmission. The communications manager 1020 may be configured as or otherwise support a means for receiving, from a second UE, a conflict indication indicating a reservation conflict for the first resource based on the control message. The communications manager 1020 may be configured as or otherwise support a means for performing resource selection to select a second resource based on receiving the conflict indication. The communications manager 1020 may be configured as or otherwise support a means for transmitting the sidelink transmission using the second resource.

Additionally or alternatively, the communications manager 1020 may support wireless communication at a first UE in accordance with examples as disclosed herein. For example, the communications manager 1020 may be configured as or otherwise support a means for transmitting a control message indicating reservation of a first resource of a sidelink channel for a sidelink transmission. The communications manager 1020 may be configured as or otherwise support a means for receiving, from a second UE, a conflict indication indicating a reservation conflict for the first resource based on the control message. The communications manager 1020 may be configured as or otherwise support a means for transmitting the sidelink transmission using the first resource.

By including or configuring the communications manager 1020 in accordance with examples as described herein, the device 1005 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of resource re-selection based on pre-conflict indication as described herein, or the processor 1040 and the memory 1030 may be otherwise configured to perform or support such operations.

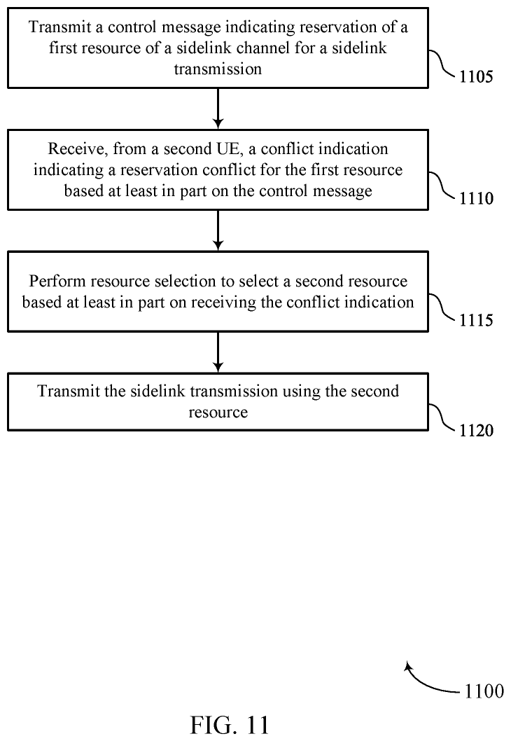

FIG. 11 shows a flowchart illustrating a method 1100 that supports resource re-selection based on pre-conflict indication in accordance with aspects of the present disclosure. The operations of the method 1100 may be implemented by a UE or its components as described herein. For example, the operations of the method 1100 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.

At 1105, the method may include transmitting a control message indicating reservation of a first resource of a sidelink channel for a sidelink transmission. The operations of 1105 may be performed in accordance with examples as disclosed herein. In some examples, aspects of the operations of 1105 may be performed by a control message transmitting component 925 as described with reference to FIG. 9.

At 1110, the method may include receiving, from a second UE, a conflict indication indicating a reservation conflict for the first resource based on the control message. The operations of 1110 may be performed in accordance with examples as disclosed herein. In some examples, aspects of the operations of 1110 may be performed by a receiving component 930 as described with reference to FIG. 9.

At 1115, the method may include performing resource selection to select a second resource based on receiving the conflict indication. The operations of 1115 may be performed in accordance with examples as disclosed herein. In some examples, aspects of the operations of 1115 may be performed by a resource selection component 935 as described with reference to FIG. 9.

At 1120, the method may include transmitting the sidelink transmission using the second resource. The operations of 1120 may be performed in accordance with examples as disclosed herein. In some examples, aspects of the operations of 1120 may be performed by a sidelink transmission component 940 as described with reference to FIG. 9.

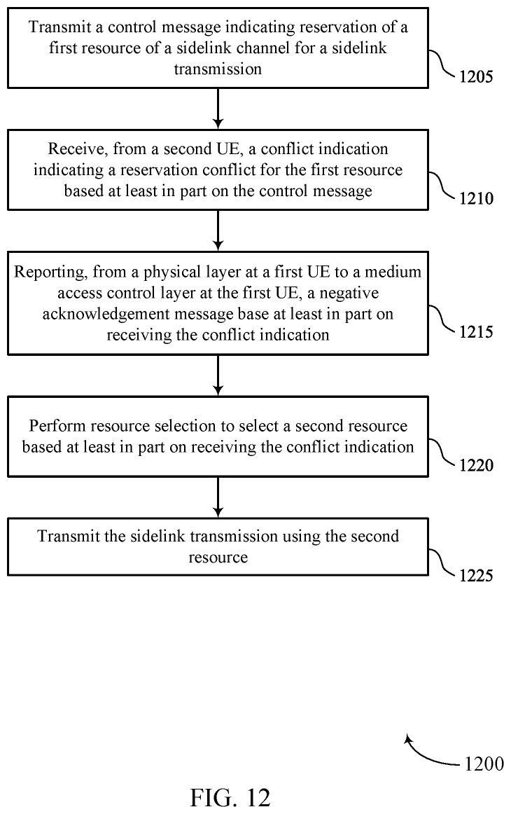

FIG. 12 shows a flowchart illustrating a method 1200 that supports resource re-selection based on pre-conflict indication in accordance with aspects of the present disclosure. The operations of the method 1200 may be implemented by a first UE or its components as described herein. For example, the operations of the method 1200 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.

At 1205, the method may include transmitting a control message indicating reservation of a first resource of a sidelink channel for a sidelink transmission. The operations of 1205 may be performed in accordance with examples as disclosed herein. In some examples, aspects of the operations of 1205 may be performed by a control message transmitting component 925 as described with reference to FIG. 9.

At 1210, the method may include receiving, from a second UE, a conflict indication indicating a reservation conflict for the first resource based on the control message. The operations of 1210 may be performed in accordance with examples as disclosed herein. In some examples, aspects of the operations of 1210 may be performed by a receiving component 930 as described with reference to FIG. 9.

At 1215, the method may include reporting, from a PHY layer at the first UE to a MAC layer at the first UE, a NACK message based on receiving the conflict indication. The operations of 1215 may be performed in accordance with examples as disclosed herein. In some examples, aspects of the operations of 1215 may be performed by a reporting component 950 as described with reference to FIG. 9.

At 1220, the method may include performing resource selection to select a second resource based on receiving the conflict indication. The operations of 1220 may be performed in accordance with examples as disclosed herein. In some examples, aspects of the operations of 1220 may be performed by a resource selection component 935 as described with reference to FIG. 9.

At 1225, the method may include transmitting the sidelink transmission using the second resource. The operations of 1225 may be performed in accordance with examples as disclosed herein. In some examples, aspects of the operations of 1225 may be performed by a sidelink transmission component 940 as described with reference to FIG. 9.

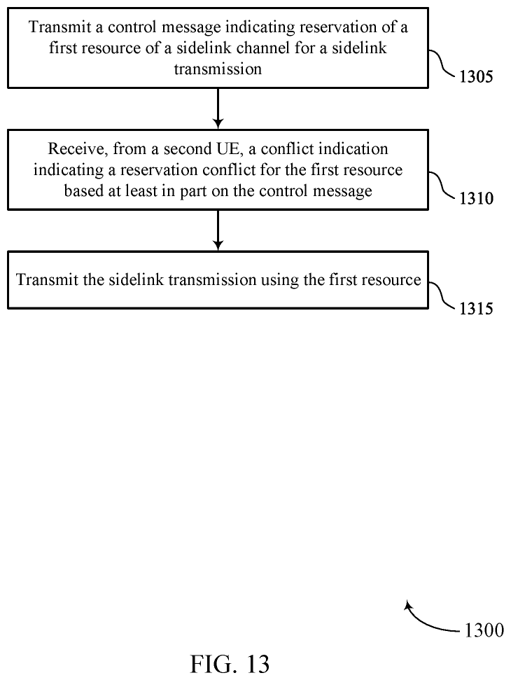

FIG. 13 shows a flowchart illustrating a method 1300 that supports resource re-selection based on pre-conflict indication in accordance with aspects of the present disclosure. The operations of the method 1300 may be implemented by a UE or its components as described herein. For example, the operations of the method 1300 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.

At 1305, the method may include transmitting a control message indicating reservation of a first resource of a sidelink channel for a sidelink transmission. The operations of 1305 may be performed in accordance with examples as disclosed herein. In some examples, aspects of the operations of 1305 may be performed by a control message transmitting component 925 as described with reference to FIG. 9.

At 1310, the method may include receiving, from a second UE, a conflict indication indicating a reservation conflict for the first resource based on the control message. The operations of 1310 may be performed in accordance with examples as disclosed herein. In some examples, aspects of the operations of 1310 may be performed by a receiving component 930 as described with reference to FIG. 9.

At 1315, the method may include transmitting the sidelink transmission using the first resource. The operations of 1315 may be performed in accordance with examples as disclosed herein. In some examples, aspects of the operations of 1315 may be performed by a sidelink transmission component 940 as described with reference to FIG. 9.

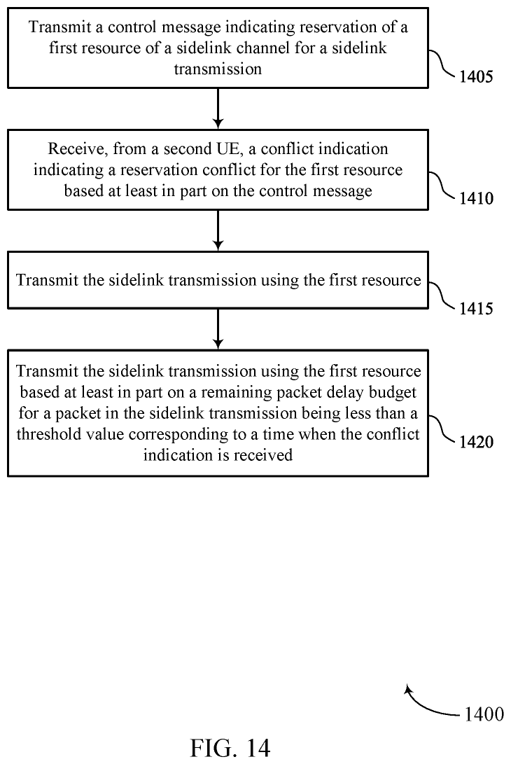

FIG. 14 shows a flowchart illustrating a method 1400 that supports resource re-selection based on pre-conflict indication in accordance with aspects of the present disclosure. The operations of the method 1400 may be implemented by a UE or its components as described herein. For example, the operations of the method 1400 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.

At 1405, the method may include transmitting a control message indicating reservation of a first resource of a sidelink channel for a sidelink transmission. The operations of 1405 may be performed in accordance with examples as disclosed herein. In some examples, aspects of the operations of 1405 may be performed by a control message transmitting component 925 as described with reference to FIG. 9.

At 1410, the method may include receiving, from a second UE, a conflict indication indicating a reservation conflict for the first resource based on the control message. The operations of 1410 may be performed in accordance with examples as disclosed herein. In some examples, aspects of the operations of 1410 may be performed by a receiving component 930 as described with reference to FIG. 9.

At 1415, the method may include transmitting the sidelink transmission using the first resource. The operations of 1415 may be performed in accordance with examples as disclosed herein. In some examples, aspects of the operations of 1415 may be performed by a sidelink transmission component 940 as described with reference to FIG. 9.

At 1420, the method may include transmitting the sidelink transmission using the first resource based on a remaining packet delay budget for a packet in the sidelink transmission being less than a threshold value corresponding to a time when the conflict indication is received. The operations of 1420 may be performed in accordance with examples as disclosed herein. In some examples, aspects of the operations of 1420 may be performed by a sidelink transmission component 940 as described with reference to FIG. 9.

The following provides an overview of aspects of the present disclosure:

Aspect 1: A method for wireless communication at a first UE, comprising: transmitting a control message indicating reservation of a first resource of a sidelink channel for a sidelink transmission; receiving, from a second UE, a conflict indication indicating a reservation conflict for the first resource based at least in part on the control message; performing resource selection to select a second resource based at least in part on receiving the conflict indication; and transmitting the sidelink transmission using the second resource.

Aspect 2: The method of aspect 1, wherein performing the resource selection further comprises: performing the resource selection based at least in part on a remaining PDB for a packet in the sidelink transmission being greater than or equal to a threshold value corresponding to a time when the conflict indication is received.

Aspect 3: The method of any of aspects 1 through 2, wherein performing the resource selection further comprises: performing the resource selection based at least in part on a priority associated with the sidelink transmission being less than a priority threshold value.

Aspect 4: The method of any of aspects 1 through 3, wherein performing the resource selection further comprises: performing the resource selection based at least in part on a conflict indication percentage during a time duration being less than a threshold percentage.

Aspect 5: The method of any of aspects 1 through 4, wherein performing the resource selection further comprises: performing the resource selection based at least in part on a conflict indication percentage for a last quantity of transmitted control messages being less than a threshold percentage.

Aspect 6: The method of any of aspects 1 through 5, wherein performing the resource selection further comprises: performing the resource selection based at least in part on a quantity of received conflict indications for consecutive resource reservations being less than a threshold.

Aspect 7: The method of any of aspects 1 through 6, further comprising: transmitting an indication of a processing time for triggering the resource selection indicating a time before the first resource when the first UE is capable of cancelling transmission of the sidelink transmission in the first resource and performing the resource selection.

Aspect 8: The method of any of aspects 1 through 7, wherein performing the resource selection comprises: performing the resource selection to select the second resource based at least in part on receiving the conflict indication at least a threshold amount of time prior to the first resource.

Aspect 9: The method of any of aspects 1 through 8, further comprising: reporting, from a PHY layer at the first UE to a MAC layer at the first UE, a NACK message based at least in part on receiving the conflict indication.

Aspect 10: A method for wireless communication at a first UE, comprising: transmitting a control message indicating reservation of a first resource of a sidelink channel for a sidelink transmission; receiving, from a second UE, a conflict indication indicating a reservation conflict for the first resource based at least in part on the control message; and transmitting the sidelink transmission using the first resource.

Aspect 11: The method of aspect 10, wherein transmitting the sidelink transmission comprises: transmitting the sidelink transmission using the first resource based at least in part on a remaining PDB for a packet in the sidelink transmission being less than a threshold value corresponding to a time when the conflict indication is received.

Aspect 12: The method of any of aspects 10 through 11 further comprising: transmitting the sidelink transmission using the first resource based at least in part on a priority associated with the sidelink transmission being greater than or equal to a priority threshold value.

Aspect 13: The method of any of aspects 10 through 12 further comprising: transmitting the sidelink transmission using the first resource based at least in part on a conflict indication percentage during a time duration being greater than or equal to a threshold percentage.

Aspect 14: The method of any of aspects 10 through 13 further comprising: transmitting the sidelink transmission using the first resource based at least in part on a conflict indication percentage for a last quantity of transmitted control messages being greater than or equal to a threshold percentage.

Aspect 15: The method of any of aspects 10 through 14 further comprising: transmitting the sidelink transmission using the first resource based at least in part on a quantity of received conflict indications for consecutive resource reservations being greater than or equal to a threshold.

Aspect 16: The method of any of aspects 10 through 15 further comprising: transmitting an indication of a processing time for triggering resource selection indicating a time before the first resource when the first UE is capable of cancelling transmission of the sidelink transmission in the first resource and performing the resource selection.

Aspect 17: An apparatus for wireless communication at a first UE, comprising a processor; memory coupled with the processor; and instructions stored in the memory and executable by the processor to cause the apparatus to perform a method of any of aspects 1 through 9.

Aspect 18: An apparatus for wireless communication at a first UE, comprising at least one means for performing a method of any of aspects 1 through 9.

Aspect 19: A non-transitory computer-readable medium storing code for wireless communication at a first UE, the code comprising instructions executable by a processor to perform a method of any of aspects 1 through 9.

Aspect 20: An apparatus for wireless communication at a first UE, comprising a processor; memory coupled with the processor; and instructions stored in the memory and executable by the processor to cause the apparatus to perform a method of any of aspects 10 through 16.

Aspect 21: An apparatus for wireless communication at a first UE, comprising at least one means for performing a method of any of aspects 10 through 16.

Aspect 22: A non-transitory computer-readable medium storing code for wireless communication at a first UE, the code comprising instructions executable by a processor to perform a method of any of aspects 10 through 16.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a first user equipment (UE), comprising:
a processor;
memory coupled with the processor; and
instructions stored in the memory and executable by the processor to cause the apparatus to:
transmit a control message indicating reservation of a first resource of a sidelink channel for a sidelink transmission;
receive, from a second UE, a conflict indication indicating a reservation conflict for the first resource based at least in part on the control message;
perform resource selection to select a second resource based at least in part on receiving the conflict indication; and
transmit the sidelink transmission using the second resource.

2. The apparatus of claim 1, wherein the instructions to perform the resource selection are further executable by the processor to cause the apparatus to:
perform the resource selection based at least in part on a remaining packet delay budget for a packet in the sidelink transmission being greater than or equal to a threshold value corresponding to a time when the conflict indication is received.

3. The apparatus of claim 1, wherein the instructions to perform the resource selection are further executable by the processor to cause the apparatus to:
perform the resource selection based at least in part on a priority associated with the sidelink transmission being less than a priority threshold value.

4. The apparatus of claim 1, wherein the instructions to perform the resource selection are further executable by the processor to cause the apparatus to:
perform the resource selection based at least in part on a conflict indication percentage during a time duration being less than a threshold percentage.

5. The apparatus of claim 1, wherein the instructions to perform the resource selection are further executable by the processor to cause the apparatus to:
perform the resource selection based at least in part on a conflict indication percentage for a last quantity of transmitted control messages being less than a threshold percentage.

6. The apparatus of claim 1, wherein the instructions to perform the resource selection are further executable by the processor to cause the apparatus to:
perform the resource selection based at least in part on a quantity of received conflict indications for consecutive resource reservations being less than a threshold.

7. The apparatus of claim 1, wherein the instructions are further executable by the processor to cause the apparatus to:
transmit an indication of a processing time for triggering the resource selection indicating a time before the first resource when the first UE is capable of cancelling transmission of the sidelink transmission in the first resource and performing the resource selection.

8. The apparatus of claim 1, wherein the instructions to perform the resource selection are executable by the processor to cause the apparatus to:
perform the resource selection to select the second resource based at least in part on receiving the conflict indication at least a threshold amount of time prior to the first resource.

9. The apparatus of claim 1, wherein the instructions are further executable by the processor to cause the apparatus to:
reporting, from a physical layer at the first UE to a medium access control layer at the first UE, a negative acknowledgement message base at least in part on receiving the conflict indication.

10. An apparatus for wireless communication at a first user equipment (UE), comprising:
a processor;
memory coupled with the processor; and
instructions stored in the memory and executable by the processor to cause the apparatus to:
transmit a control message indicating reservation of a first resource of a sidelink channel for a sidelink transmission;
receive, from a second UE, a conflict indication indicating a reservation conflict for the first resource based at least in part on the control message; and
transmit the sidelink transmission using the first resource.

11. The apparatus of claim 10, wherein the instructions to transmit the sidelink transmission are executable by the processor to cause the apparatus to:
transmit the sidelink transmission using the first resource based at least in part on a remaining packet delay budget for a packet in the sidelink transmission being less than a threshold value corresponding to a time when the conflict indication is received.

12. The apparatus of claim 10, wherein the instructions are further executable by the processor to cause the apparatus to:
transmit the sidelink transmission using the first resource based at least in part on a priority associated with the sidelink transmission being greater than or equal to a priority threshold value.

13. The apparatus of claim 10, wherein the instructions are further executable by the processor to cause the apparatus to:
transmit the sidelink transmission using the first resource based at least in part on a conflict indication percentage during a time duration being greater than or equal to a threshold percentage.

14. The apparatus of claim 10, wherein the instructions are further executable by the processor to cause the apparatus to:
transmit the sidelink transmission using the first resource based at least in part on a conflict indication percentage for a last quantity of transmitted control messages being greater than or equal to a threshold percentage.

15. The apparatus of claim 10, wherein the instructions are further executable by the processor to cause the apparatus to:
transmit the sidelink transmission using the first resource based at least in part on a quantity of received conflict indications for consecutive resource reservations being greater than or equal to a threshold.

16. The apparatus of claim 10, wherein the instructions are further executable by the processor to cause the apparatus to:
transmit an indication of a processing time for triggering resource selection indicating a time before the first resource when the first UE is capable of cancelling transmission of the sidelink transmission in the first resource and performing the resource selection.

17. A method for wireless communication at a first user equipment (UE), comprising:
transmitting a control message indicating reservation of a first resource of a sidelink channel for a sidelink transmission;
receiving, from a second UE, a conflict indication indicating a reservation conflict for the first resource based at least in part on the control message;
performing resource selection to select a second resource based at least in part on receiving the conflict indication; and
transmitting the sidelink transmission using the second resource.

18. The method of claim 17, wherein performing the resource selection further comprises:
performing the resource selection based at least in part on a remaining packet delay budget for a packet in the sidelink transmission being greater than or equal to a threshold value corresponding to a time when the conflict indication is received.

19. The method of claim 17, wherein performing the resource selection further comprises:
performing the resource selection based at least in part on a priority associated with the sidelink transmission being less than a priority threshold value.

20. The method of claim 17, wherein performing the resource selection further comprises:
performing the resource selection based at least in part on a conflict indication percentage during a time duration being less than a threshold percentage.

21. The method of claim 17, wherein performing the resource selection further comprises:
performing the resource selection based at least in part on a conflict indication percentage for a last quantity of transmitted control messages being less than a threshold percentage.

22. The method of claim 17, wherein performing the resource selection further comprises:
performing the resource selection based at least in part on a quantity of received conflict indications for consecutive resource reservations being less than a threshold.

23. The method of claim 17, further comprising:
transmitting an indication of a processing time for triggering the resource selection indicating a time before the first resource when the first UE is capable of cancelling transmission of the sidelink transmission in the first resource and performing the resource selection.

24. The method of claim 17, wherein performing the resource selection comprises:
performing the resource selection to select the second resource based at least in part on receiving the conflict indication at least a threshold amount of time prior to the first resource.

25. The method of claim 17, further comprising:
reporting, from a physical layer at the first UE to a medium access control layer at the first UE, a negative acknowledgement message based at least in part on receiving the conflict indication.

26. A method for wireless communication at a first user equipment (UE), comprising:
transmitting a control message indicating reservation of a first resource of a sidelink channel for a sidelink transmission;
receiving, from a second UE, a conflict indication indicating a reservation conflict for the first resource based at least in part on the control message; and
transmitting the sidelink transmission using the first resource.

27. The method of claim 26, wherein transmitting the sidelink transmission comprises:
transmitting the sidelink transmission using the first resource based at least in part on a remaining packet delay budget for a packet in the sidelink transmission being less than a threshold value corresponding to a time when the conflict indication is received.

28. The method of claim 26 further comprising:
transmitting the sidelink transmission using the first resource based at least in part on a priority associated with the sidelink transmission being greater than or equal to a priority threshold value.

29. The method of claim 26 further comprising:
transmitting the sidelink transmission using the first resource based at least in part on a conflict indication percentage during a time duration being greater than or equal to a threshold percentage.

30. The method of claim 26 further comprising:
transmitting the sidelink transmission using the first resource based at least in part on a conflict indication percentage for a last quantity of transmitted control messages being greater than or equal to a threshold percentage.
